(19) United States
(12) Patent Application Publication
(10) Pub. No.: US 2013/0344226 A1
(43) Pub. Date: Dec. 26, 2013

(54) OIL OR FAT COMPOSITION FOR PROCESSED SEA FOODS, AND PROCESSED SEA FOOD COMPRISING SAME

(71) Applicant: Isamu Takahashi, Yokohama-shi (JP)

(72) Inventor: Isamu Takahashi, Yokohama-shi (JP)

(73) Assignee: TAIYO YUSHI CORP., Yokohama-shi, Kanagawa (JP)

(21) Appl. No.: 13/982,631

(22) PCT Filed: Jan. 31, 2012
(86) PCT No.: PCT/JP2012/052129

§ 371 Date: Sep. 9, 2013

(30) Foreign Application Priority Data
Jan. 31, 2011 (JP) 2011-018119

(51) Int. Cl. A23D 9/00

(52) U.S. Cl. CPC A23D 9/00
USPC 426/601; 426/643

(57) ABSTRACT

A fat or fatty oil composition for a processed sea food contains 10% by mass or more of a transesterified fat or fatty oil obtained by using at least one palm-based fat or fatty oils or more as a raw material, and has a solid fat content (SFC) at 0° C. to 10° C. of 5 to 25%. The fat or fatty oil composition thus obtained has a moderate hardness and smoothness as well as excellent melt-in-the-mouth, and has a reduced trans fatty acid content.

### TECHNICAL FIELD

The present invention relates to a fat or fatty oil (oil or fat) composition used for a processed sea food. More specifically, the present invention relates to a fat or fatty oil composition which has a low trans fatty acid content, which is readily dispersed in a processed sea food during the production thereof, and which enables production of a processed sea food having a smooth mouthfeel, and also relates to a processed sea food produced by using the fat or fatty oil composition.

### BACKGROUND ART

Processed sea foods obtained by grinding a sea food such as red meat of tuna or smoked salmon with a food processor or the like, and adding a fat or fatty oil or a shortening thereto, followed by kneading are widely used as they are, and as ingredients of Sushi, fillings of rice balls, and the like. In the production process of these processed sea foods, the sea foods are often processed under lower temperature conditions than a cold storage temperature range (10° C.) in order to maintain the freshness of the sea foods. As for the fat or fatty oil or the shortening used in this process, an important factor in the workplace is that it should have moderate softness and smoothness even under such temperature conditions. In addition, when the fat or fatty oil or shortening is provided in the form of a processed sea food, the melt-in-the-mouth of the fat or fatty oil or shortening is very important.

Patent Documents 1 and 2 show a processing method for obtaining a processed product of red meat of tuna, the method comprising: grinding the red meat of tuna with a mincer, and adding a shortening having a gas content of 5 to 20 ml/100 g thereto, followed by kneading.

### CITATION LIST

### Patent Literatures Patent Literature 1: Japanese Patent 2676193

Patent Literature 2: Japanese Examined Patent Application Publication No. Hei 05-004061

### SUMMARY OF INVENTION

### Technical Problems

NEGITORO (minced fatty tuna)-like processed sea foods produced by grinding a sea food such as red meat of tuna or smoked salmon with a food processor or the like are often produced by mixing a fat or fatty oil composition for a processed sea food or the fat or fatty oil composition prepared in the form of a shortening.

In order to make the processed sea foods tasty, it is very important for the fat or fatty oil composition for a processed sea food to have a moderate hardness and smoothness, as well as a texture of melt-in-the-mouth, which means rapid melting in the mouth.

In addition, the moderate hardness and smoothness are very important factors for physical properties of rapidly achieving a well-mixing of the fat or fatty oil composition in the production of these processed sea foods.

Conventionally, fat or fatty oil compositions whose physical properties are adjusted by mixing a vegetable fat or fatty oil, such as corn oil, which is liquid at room temperature with a partially hydrogenated fat or fatty oil have been used as the fat or fatty oil composition for a processed sea food.

However, since a partially hydrogenated fat or fatty oil is used, most of such fat or fatty oil compositions contain 5% or more of trans fatty acids, and there is an increasing demand for reduction of trans fatty acids.

It is conceivable that a palm-based fat or fatty oil, or a lauric fat or fatty oil such as coconut oil, palm kernel oil, and one obtained by fully hardening any of these can be used to obtain a moderate hardness. However, palm-based fat or fatty oil tends to form coarse and large crystals, and lauric fat or fatty oil is too hard at low temperatures. Hence, a moderate hardness or smoothness cannot be obtained, and it is difficult to obtain physical properties excellent in both workability and mouthfeel.

### Means to solve Problems

The present inventors have found that the above-described problems can be solved by blending a transesterified fat or fatty oil obtained from at least one palm-based fat or fatty oil as a raw material. This finding has led to the completion of the present invention.

The present invention is as follows.

(1) A fat or fatty oil composition for a processed sea food, comprising:

a transesterified fat or fatty oil in an amount of 10% by mass or more relative to the total mass of the fat or fatty oil composition for a processed sea food, the transesterified fat or fatty oil being obtained by transesterifying a raw material fat or fatty oil containing a palm-based fat or fatty oil, wherein

the fat or fatty oil composition has a solid fat content (SFC) at 0° C. to 10° C. of 5 to 25%.

(2) The fat or fatty oil composition for a processed sea food according to (1), further comprising a vegetable fat or fatty oil which is liquid at 25° C. in an amount of 30 to 90% by mass relative to the total mass of the fat or fatty oil composition for a processed sea food.
(3) The fat or fatty oil composition for a processed sea food according to (1) ₒᵣ (2), which has a trans fatty acid content of lower than 5% by mass.
(4) The fat or fatty oil composition for a processed sea food according to any one of (1) to (3), wherein

the raw material fat or fatty oil of the transesterified fat or fatty oil contains a palm-based fat or fatty oil in an amount of 10 to 100% by mass.

(5) The fat or fatty oil composition for a processed sea food according to any one of (2) to (4), wherein

the vegetable fat or fatty oil which is liquid at 25° C. is a fat or fatty oil selected from the group consisting of corn oil, soybean oil, rapeseed oil, safflower oil, rice bran oil, cottonseed oil, sunflower oil, palm oil, and fat or fatty oil mixtures of two or more of these oils.

(6) The fat or fatty oil composition for a processed sea food according to any one of (1) to (5), wherein

the palm-based fat or fatty oil contained in the raw material fat or fatty oil of the transesterified fat or fatty oil is at least one fat or fatty oil selected from the group consisting of palm, palm olein, and palm super olein, or a mixture thereof.

(7) A shortening for a processed sea food, which is obtained by kneading, with rapid cooling, the fat or fatty oil composition for a processed sea food according to any one of (1) to (6).
(8) A processed sea food, which is produced by using the fat or fatty oil composition for a processed sea food according to any one of (1) to (6), or the shortening according to (7).
(9) The processed sea food according to (8), which is a ground product of a sea food selected from the group consisting of tuna, salmon, Japanese amberjack, mackerel, and squid.

### Advantageous Effects of Invention

The use of the fat or fatty oil composition for a processed sea food of the present invention makes it possible to provide a processed sea food which has smooth physical properties and excellent melt-in-the-mouth in spite of being solid at low temperatures and further which has a reduced trans fatty acid content.

### DESCRIPTION OF EMBODIMENTS

### Fat or Fatty Oil Composition for Processed Sea Food

A fat or fatty oil composition for a processed sea food of the present invention is a fat or fatty oil composition used by being mixed in a NEGITORO-like processed sea food, which is produced by grinding a sea food such as tuna or salmon in a food processor or the like, in order to impart good tastes such as moderate hardness, smoothness, and melt-in-the-mouth to the processed sea food.

The fat or fatty oil composition for a processed sea food of the present invention comprises a transesterified fat or fatty oil in an amount of 10% by mass or more relative to the total mass of the fat or fatty oil composition for a processed sea food, the transesterified fat or fatty oil being obtained by transesterifying a raw material fat or fatty oil containing a palm-based fat or fatty oil, and has a solid fat content (SFC) at 0° C. to 10° C. of 5 to 25%.

The raw material fat or fatty oil of the transesterified fat or fatty oil in the fat or fatty oil composition for a processed sea food contains at least one palm-based fat or fatty oil. This is because the trans acid content can be lowered, and the physical properties can be easily adjusted. It is possible to use a non-transesterified palm-based fat or fatty oil in combination. However, if a transesterified fat or fatty oil obtained by using a palm-based fat or fatty oil as a raw material is not used, but a non-transesterified palm-based fat or fatty oil alone is used, smoothness of the fat or fatty oil composition will be lost, resulting in a hard and gritty mouthfeel.

Examples of the palm-based fat or fatty oil include palm oil, partially hydrogenated palm oil, fractionated palm oils, partially hydrogenated fractionated palm oils, and fats or fatty oils obtained by transesterifying one or more thereof. The partially hydrogenated palm oil is obtained by partially hydrogenating palm oil. The fractionated palm oils are fats or fatty oils which include a high-melting point fraction, a middle-melting point fraction, and a low-melting point fraction obtained by subjecting palm oil to a fractionation treatment. In addition, those obtained by further fractionating any of the obtained fractions can also be used. The partially hydrogenated fractionated palm oils refer to those obtained by further partially hydrogenating any of the fractionated palm oils, or fractions obtained by subjecting the partially hydrogenated palm oil to a fractionation treatment.

The palm-based fat or fatty oil contained in the raw material fat or fatty oil of the transesterified fat or fatty oil is preferably at least one fat or fatty oil selected from the group consisting of palm, palm olein, and palm super olein, or a mixture thereof.

The above-described transesterified fat or fatty oil can be further mixed with another fat or fatty oil, and used as the fat or fatty oil composition for a processed sea food. Examples of the fat or fatty oil, other than the palm-based fat or fatty oil, usable for the transesterified fat or fatty oil include vegetable fats and fatty oils which are liquid at 25° C., such as corn oil, rapeseed oil, soybean oil, cottonseed oil, and sunflower oil. Corn oil and rapeseed oil are preferable.

The raw material fat or fatty oil of the transesterified fat or fatty oil contains the palm-based fat or fatty oil in an amount of preferably 10 to 100% by mass, more preferably 20% by mass or more, further preferably 30% by mass or more, and most preferably 40% by mass or more.

The transesterified fat or fatty oil obtained by transesterifying the raw material fat or fatty oil containing the palm-based fat or fatty oil is contained in an amount of 10% by mass or more relative to the total mass of the fat or fatty oil composition for a processed sea food. The transesterified fat or fatty oil is contained more preferably in a range from 10 to 100% by mass, further preferably 30 to 90% by mass, and furthermore most preferably in a range from 40 to 80% by mass.

The fat or fatty oil composition for a processed sea food may further contain a vegetable fat or fatty oil which is liquid at 25° C. The vegetable fat or fatty oil which is liquid at 25° C. is contained in a range of preferably from 15 to 90% by mass, more preferably from 15 to 70% by mass, and further preferably from 20 to 60% by mass, relative to the total mass of the fat or fatty oil composition for a processed sea food. The vegetable fat or fatty oil which is liquid at 25° C. may be any, as long as the vegetable fat or fatty oil is an edible fat or fatty oil which is derived from a plant, and which is in a liquid state or a fluid state at 25° C. It does not matter if the appearance of the vegetable fat or fatty oil is in a transparent state or a white turbid state, as long as the entire part of the vegetable fat or fatty oil is in a liquid state. More preferably, the vegetable fat or fatty oil desirably has a clear appearance without turbidity.

The raw material fat or fatty oil of the liquid fat or fatty oil is preferably a fat or fatty oil selected from the group consisting of corn oil, soybean oil, rapeseed oil, safflower oil, rice bran oil, cottonseed oil, sunflower oil, palm oil, and fat or fatty oil mixtures of two or more of the oils.

Preferred examples of the liquid fat or fatty oil include corn oil, rapeseed oil, palm oil, and fractionated oils of these oils. The liquid fat or fatty oil is further preferably corn oil, rapeseed oil, palm oil, palm olein, or palm super olein, and is most preferably corn oil.

The fat or fatty oil composition for a processed sea food of the present invention has a solid fat content (SFC) at 0° C. to 10° C. of 5 to 25%. A solid fat content (SFC) in this range results in favorable workability and flavor. The solid fat content at 0° C. to 10° C. of 5 to 25% means that the solid fat contents at temperatures of both 0° C. and 10° C. are both in the range from 5 to 25%. The solid fat content at 0° C. to 10° C. is preferably 5 to 20%, and further preferably 10 to 20%.

A solid fat content at 0° C. to 10° C. exceeding 25% is not preferable, because both the workability and the flavor deteriorate. In addition, a solid fat content at 0° C. to 10° C. of less than 5% is not preferable, because the flavor deteriorates.

The solid fat content (SFC) can be determined by, for example, “Solid Fat Content (NMR)” described in “Standard Methods for the Analysis of Fats, Oils and Related Materials” (2007), edited by Japan Oil Chemists' Society.

The trans fatty acid content of the fat or fatty oil composition for a processed sea food is preferably 5% by mass or less, further preferably 3% by mass or less, and more preferably 1% by mass or less.

The trans fatty acid content can be determined by, for example, “Trans Fatty Acid Content (capillary gas chromatography)” described in “Standard Methods for the Analysis of Fats, Oils and Related Materials” (2007), edited by Japan Oil Chemists' Society.

The fat or fatty oil composition for a processed sea food of the present invention can also be used as a shortening which is prepared by completely melting the fat or fatty oil composition with heating at 50 to 60° C., and then kneading the fat or fatty oil composition with rapid cooling to about 0 to 10° C.

The “fat or fatty oil composition for a processed sea food” herein refers to a fat or fatty oil composition to be added in the processing of a sea food such as tuna or salmon by grinding or the like.

The sea food to which the fat or fatty oil composition is added is a ground product of a sea food selected from the group consisting of tuna, salmon, Japanese amberjack, mackerel, and squid. Of these sea foods, tuna and salmon are preferable, red meat of tuna and smoked salmon are more preferable, and red meat of tuna is particularly preferable.

These processed sea foods are eaten as they are, or used as ingredients of Sushi, fillings of rice balls, and the like.

### EXAMPLES

### Example 1 to 18 and Comparative Examples 1 to 8

### Preparation of Transesterified Fats or Fatty Oils

Raw material fats or fatty oils were mixed at the blending proportions shown in Table 1, and the resultant fats or fatty oils were dried by being heated under reduced pressure. An alkali catalyst was added to the fats or fatty oils, and transesterification reaction was conducted. More specifically, after the raw material fats or fatty oils were mixed, water remaining in each fat or fatty oil was removed by heating to 110° C. under a reduced pressure of 0.05 MPa in a transesterification reaction vessel.

After that, the fat or fatty oil was cooled to 90° C., and vacuum evacuation was stopped, while nitrogen was introduced. While the contact of the fat or fatty oil with the air was avoided, the alkali catalyst (sodium methoxide) was added in an amount of 0.1% by mass relative to the fat or fatty oil. Thus, transesterification reaction was started. Thirty minutes later, the transesterification reaction was stopped by adding water in the same amount as the fat or fatty oil. After that, the water was removed by decantation and by drying under reduced pressure. Thus, transesterified oils were obtained.

### Preparation of Fat or Fatty Oil Compositions

Raw materials were mixed at the blending proportions shown in Tables 2 to 4, and decolorization and deodorization operations were performed in a usual manner. Thus, purified fat or fatty oil compositions were obtained.

Specifically, activated clay was added to each of the mixtures of the raw material fats or fatty oils, and the mixture was heated to 110° C. under reduced pressure (0.09 MPa) with stirring, held for 15 minutes, and then cooled to 80° C. The mixture was filtered through a filter paper to remove the activated clay, and a decolored oil was obtained. The decolored oil was subjected to deodorization at 250° C. under reduced pressure (300 Pa). Thus, purified fat or fatty oil compositions of Examples 6 to 18 and Comparative Examples 1 to 8 were obtained.

### Preparation of Shortenings

Each of the above-described fat or fatty oil compositions was heated to 60° C., and completely melted. The fat or fatty oil composition was further kneaded with rapid cooling to around 5° C. Thus, shortenings were prepared.

### Evaluation by Preparing Food

Into a food processor, 100 g of red meat of tuna was placed, and ground for 5 seconds. Further, 15 g of each of the fat or fatty oil compositions of Examples 6 to 18 and Comparative Examples 1 to 8 prepared into the form of the shortenings was added to the food processor, followed by mixing for 5 seconds. Thus, NEGITORO-like processed sea foods of Examples 6 to 18 and Comparative Examples 1 to 8 were obtained. Here, the easiness of mixing of each shortening was evaluated as workability.

### Evaluation Criteria of Workability

A: Very rapidly dispersed in fish meat
B: Well dispersed in fish meat
C1: Well dispersed in fish meat, but sticky
C2: Hard, and slightly difficult to mix with fish meat
D: Hard, and difficult to mix with fish meat

The NEGITORO-like processed sea foods of Examples 6 to 18 and Comparative Examples 1 to 8 were evaluated in terms of differences in flavor, melt-in-the-mouth, texture, and the like by 20 panelists who ate the NEGITORO-like processed sea foods. Tables 5 to 7 show the results.

### Evaluation Criteria of Flavor

A: Very smooth and excellent in melt-in-the-mouth
B: Smooth and excellent in melt-in-the-mouth
C1: Slightly gritty in mouthfeel
C2: Sticky and oily
D: Poor in melt-in-the-mouth and oily

As can be understood from Tables 5 to 7, the fat or fatty oil compositions for a processed sea food, which contained a transesterified oil using at least one palm-based raw material or more, offered good workability, because the fat or fatty oil compositions were smooth and moderately well mixed with fish meat during mixing. In addition, the fat or fatty oil compositions offered smooth mouthfeel and excellent melt-in-the-mouth, when eaten. On the other hand, the fat or fatty oil compositions for a processed sea food not using any of the above-described transesterified oils were too hard, and lacked smoothness. Hence, the fat or fatty oil compositions were difficult to mix with fish meat during mixing, and resulted in a poor workability. In addition, when eaten, the fat or fatty oil compositions gave gritty mouth feel and resulted in insufficient melt-in-the-mouth.

TABLE 1
Blending proportions of transesterified fats or fatty oils

| | | Examples | | | | |
|---|---|---|---|---|---|---|
| | | 1 | 2 | 3 | 4 | 5 |
| Raw material fat | Palm super olein (iodine | 50 | 60 | 70 | | |
| or fatty oil | value: 65) (% by mass) | | | | | |
| | Palm olein (iodine value: 57) | 50 | | | | 40 |
| | (% by mass) | | | | | |
| | Palm oil (% by mass) | | | 30 | 35 | |
| | Rapeseed oil (% by mass) | | 40 | | | |
| | Corn oil (% by mass) | | | | 65 | 60 |

TABLE 2
Blending proportions of fat or fatty oil compositions for processed sea foods, and trans fatty acid contents thereof

| | | | | | | | Comparative | | |
|---|---|---|---|---|---|---|---|---|---|
| | | Example | | | | | Example | | |
| | | 6 | 7 | 8 | 9 | 10 | 1 | 2 | 3 |
| Blending proportion of fats and | Fat or fatty oil of Ex. 1 | 40 | 30 | 25 | 20 | 15 | — | — | 60 |
| fatty oils (% by mass) | Fat or fatty oil of Ex. 2 | — | — | — | — | — | — | — | — |
| | Fat or fatty oil of Ex. 3 | — | — | — | — | — | — | — | — |
| | Fat or fatty oil of Ex. 4 | — | — | — | — | — | — | — | — |
| | Fat or fatty oil of Ex. 5 | — | — | — | — | — | — | — | — |
| | Corn oil | 60 | 70 | 75 | 65 | 65 | 60 | 75 | 40 |
| | Rapeseed oil | — | — | — | — | — | — | — | — |
| | Palm oil | — | — | — | — | — | — | — | — |
| | Palm olein | — | — | — | 15 | 20 | 20 | 12.5 | — |
| | Palm super olein | — | — | — | — | — | 20 | 12.5 | — |

| | | | | | | | | |
|---|---|---|---|---|---|---|---|---|
| Trans fatty acid content (% by mass)* | 0.6 | 0.5 | 0.5 | 0.4 | 0.4 | 0.3 | 0.5 | 0.3 |
| SFC at 0° C. (%) | 18.2 | 13.3 | 11.6 | 15.1 | 13.0 | 12.5 | 7.3 | 27.1 |
| SFC at 10° C. (%) | 11.3 | 7.6 | 5.6 | 10.3 | 7.6 | 7.0 | 4.8 | 21.6 |

*Each trans fatty acid content is expressed in percentage by mass of trans fatty acids relative to the total mass of the transesterified fat or fatty oil.

TABLE 3
Blending proportions of fat or fatty oil compositions for processed sea foods, and trans fatty acid contents thereof

| | | | | | | | Comparative | | |
|---|---|---|---|---|---|---|---|---|---|
| | | Example | | | | | Example | | |
| | | 11 | 12 | 13 | 14 | 15 | 4 | 5 | 6 |
| Blending proportion of fats and | Fat or fatty oil of Ex. 1 | — | — | — | — | — | — | — | — |
| fatty oils (% by mass) | Fat or fatty oil of Ex. 2 | 100 | 80 | 60 | 70 | 50 | — | — | 80 |
| | Fat or fatty oil of Ex. 3 | — | — | — | — | — | — | — | — |
| | Fat or fatty oil of Ex. 4 | — | — | — | — | — | — | — | — |
| | Fat or fatty oil of Ex. 5 | — | — | — | — | — | — | — | — |
| | Corn oil | — | 20 | 40 | 15 | 30 | — | 40 | — |
| | Rapeseed oil | — | — | — | — | — | 40 | 24 | — |
| | Palm oil | — | — | — | — | — | — | — | — |
| | Palm olein | — | — | — | 15 | 20 | — | — | 20 |
| | Palm super olein | — | — | — | — | — | 60 | 36 | — |

| | | | | | | | | |
|---|---|---|---|---|---|---|---|---|
| Trans fatty acid content (% by mass)* | 0.8 | 0.7 | 0.5 | 0.6 | 0.4 | 0.4 | 0.6 | 0.7 |
| SFC at 0° C. (%) | 23.5 | 18.2 | 10.8 | 23.3 | 12.3 | 3.8 | 2.6 | 29.1 |
| SFC at 10° C. (%) | 12.8 | 10.6 | 8.0 | 14.5 | 6.8 | 1.0 | 0.5 | 18.4 |

TABLE 4
Blending proportions of fat or fatty oil compositions for processed sea
foods, and trans fatty acid contents thereof

| | | | | | Comparative | |
|---|---|---|---|---|---|---|
| | | Example | | | Example | |
| | | 16 | 17 | 18 | 7 | 8 |
| Blending | Fat or fatty oil of Ex. 1 | — | — | — | — | — |
| proportion | Fat or fatty oil of Ex. 2 | — | — | — | — | — |
| of fats and | Fat or fatty oil of Ex. 3 | 10 | — | — | — | — |
| fatty oils | Fat or fatty oil of Ex. 4 | — | 40 | — | — | — |
| (% by mass) | Fat or fatty oil of Ex. 5 | — | — | 50 | — | — |
| | Corn oil | 70 | 60 | — | 40 | — |
| | Rapeseed oil | — | — | 50 | — | 50 |
| | Palm oil | 10 | — | — | — | 10 |
| | Palm olein | 10 | — | — | 60 | 20 |

| | | | | | |
|---|---|---|---|---|---|
| Trans fatty acid content (% by mass)* | 0.8 | 0.9 | 1.5 | 0.8 | 1.5 |
| SFC at 0° C. (%) | 18.8 | 14.2 | 11.0 | 29.1 | 18.3 |
| SFC at 10° C. (%) | 10.5 | 11.6 | 5.1 | 20.3 | 13.2 |

TABLE 5
Results of evaluation of fat or fatty oil compositions for processed sea food in NEGITORO-like processed sea foods

| Fat or fatty oil | Example | Example | Example | Example | Example | Comp. Ex. | Comp. Ex. | Comp. Ex. |
|---|---|---|---|---|---|---|---|---|
| composition used | 6 | 7 | 8 | 9 | 10 | 1 | 2 | 3 |
| Workability evaluation | A | A | A | B | A | B | A | D |
| Flavor evaluation | A | B | B | A | B | C1 | C1 | D |

TABLE 6
Results of evaluation of fat or fatty oil compositions for processed sea food in NEGITORO-like processed sea foods

| Fat or fatty oil | Example | Example | Example | Example | Example | Comp. Ex. | Comp. Ex. | Comp. Ex. |
|---|---|---|---|---|---|---|---|---|
| composition used | 11 | 12 | 13 | 14 | 15 | 4 | 5 | 6 |
| Workability evaluation | B | A | A | B | A | C1 | C1 | D |
| Flavor evaluation | B | A | B | A | B | C2 | C2 | D |

TABLE 7
Results of evaluation of fat or fatty oil compositions for
processed sea food in NEGITORO-like processed sea foods

| | | | | Comp. | Comp. |
|---|---|---|---|---|---|
| Fat or fatty oil | Example | Example | Example | Ex. | Ex. |
| composition used | 16 | 17 | 18 | 7 | 8 |
| Workability | B | B | A | D | C2 |
| evaluation | | | | | |
| Flavor evaluation | B | B | A | C1 | D |

1-9. (canceled)

10. A fat or fatty oil composition for a processed sea food, comprising:
a transesterified fat or fatty oil in an amount of 10% by mass or more relative to the total mass of the fat or fatty oil composition for a processed sea food, the transesterified fat or fatty oil being obtained by transesterifying a raw material fat or fatty oil containing a palm-based fat or fatty oil,
wherein the fat or fatty oil composition has a solid fat content at 0° C. to 10° C. of 5 to 25%.

11. The fat or fatty oil composition for a processed sea food according to claim 10, further comprising a vegetable fat or fatty oil which is liquid at 25° C. in an amount of 15 to 90% by mass relative to the total mass of the fat or fatty oil composition for a processed sea food.

12. The fat or fatty oil composition for a processed sea food according to claim 10, which has a trans fatty acid content of 5% by mass or lower.

13. The fat or fatty oil composition for a processed sea food according to claim 10, wherein the raw material fat or fatty oil of the transesterified fat or fatty oil contains a palm-based fat or fatty oil in an amount of 10 to 100% by mass.

14. The fat or fatty oil composition for a processed sea food according to claim 11, wherein the vegetable fat or fatty oil which is liquid at 25° C. is a fat or fatty oil selected from the group consisting of corn oil, soybean oil, rapeseed oil, safflower oil, rice bran oil, cottonseed oil, sunflower oil, palm oil, and fat or fatty oil mixtures of two or more of these oils.

15. The fat or fatty oil composition for a processed sea food according to claim 10, wherein the palm-based fat or fatty oil contained in the raw material fat or fatty oil of the transesterified fat or fatty oil is at least one fat or fatty oil selected from the group consisting of palm, palm olein, and palm super olein, or a mixture thereof.

16. A shortening for a processed sea food, which is obtained by kneading, with rapid cooling, the fat or fatty oil composition for a processed sea food according to claim 10.

17. A processed sea food, which contains the fat or fatty oil composition for a processed sea food according to claim 10.

18. The processed sea food according to claim 17, which is a ground product of a sea food selected from the group consisting of tuna, salmon, Japanese amberjack, mackerel, and squid.
